(19) United States
(12) Patent Application Publication
(10) Pub. No.: US 2005/0268036 A1
(43) Pub. Date: Dec. 1, 2005

(54) Storage configuration

(75) Inventor: Keith R. Kinnan, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/999,178

(22) Filed: Nov. 29, 2004

Related U.S. Application Data
(60) Provisional application No. 60/574,726, filed on May 27, 2004.

(51) Int. Cl. G06F 12/00

(52) U.S. Cl. 711/114; 711/170

(57) ABSTRACT

In at least some embodiments, a storage unit, and associated system and method, comprises a plurality of storage devices, a user input device and a storage controller. The storage controller couples to the user input device and to the storage devices and is capable of configuring the storage devices in accordance with a selection made by the user via the input device.

### BACKGROUND

Some storage systems comprising a plurality of storage devices may be operated according to any one of a variety of configurations. Such storage systems are configured prior to their use in accordance with the desired configuration. User friendly mechanisms and procedures for configuring the storage systems are desirable.

### BRIEF SUMMARY

In at least some embodiments, a storage unit, and associated system and method, comprises a plurality of storage devices, a user input device and a storage controller. The storage controller couples to the user input device and to the storage devices and is capable of configuring the storage devices in accordance with a selection made by the user via the input device.

### BRIEF DESCRIPTION OF THE DRAWINGS

For a detailed description of exemplary embodiments of the invention, reference will now be made to the accompanying drawings in which:

FIG. 1 shows a system in accordance various embodiments that permits a user to configure a storage unit by activating a control on the storage unit; and

FIG. 2 shows a method in accordance with various embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

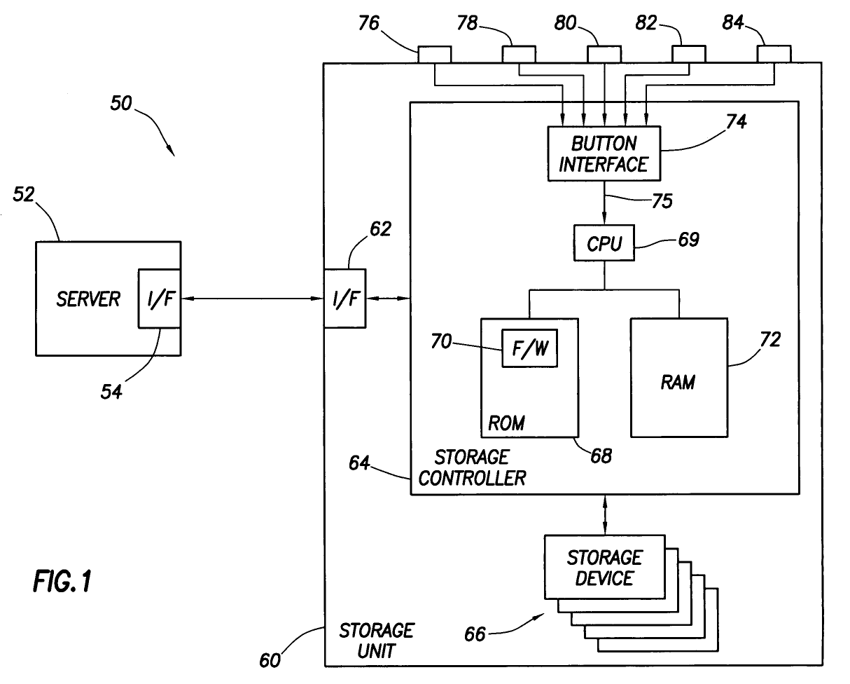

Referring now to FIG. 1, a system 50 is shown in accordance with various embodiments of the invention. As shown, the system 50 may comprise a server 52 coupled to a storage unit 60. The server 52 includes an interface 54 and the storage unit 60 includes a corresponding interface 62 to facilitate the communication therebetween. The communication link between interfaces 54 and 62 may be implemented in accordance with any suitable communication protocol such as the Small Computer System Interface (“SCSI”) or Fibre channel protocols. The storage unit 60 is used by the server 52 for storage and retrieval of data. As such, the storage unit 60 includes one or more storage devices 66 that may comprise hard disk drives or other suitable types of storage devices.

In addition to the storage devices 66, the storage unit 60 includes a storage controller 64. The storage controller 64 includes a central processing unit (“CPU”) 69 coupled to a read only memory (“ROM”) 68, to a random access memory (“RAM”) 72, and to a button interface 74. The ROM 68 contains firmware 70 that is executable by the CPU 69. During initialization of the storage unit 60, the firmware 70 may be copied to RAM 72 and thus may be executed by the CPU 66 from the RAM. Either or both of the ROM 68 and RAM 72 comprise a storage medium on which executable code is stored and executed by the CPU 69. The firmware 70 may be stored on other forms of storage as well. The firmware 70 causes the CPU 69 to perform one or more of the actions described herein.

One or more user-activated input control devices are provided on a user-accessible outer surface of the storage unit 60. If desired, the input control device(s) may be located on an exposed outer surface of a printed circuit board containing the storage controller 64. In at least some embodiments, the input control devices comprise user-activated buttons 76, 78, 80, 82, and 84, although other forms of input control devices are acceptable as well, such as a rotatable knob or a slider mechanism. Although five buttons 76-84 are shown in the embodiment of FIG. 1, any number of buttons (i.e., one or more) are acceptable. The button interface 74 couples to the buttons 76-84 and detects when one or more of the buttons are activated by a user. When the button interface 74 detects that a user has activated one of the buttons, the button interface 74 asserts an interrupt signal 75 to the CPU 69. In other embodiments, interrupt processing circuitry may be included in the storage controller 64 to react to the button interface's determination that a button has been activated and assert an interrupt to the CPU.

The storage devices 66 can be configured to operate in any of a plurality of configurations such as any of a variety of Redundant Array of Independent Disks (“RAID”). Such configurations may include RAID0, RAID1+0, RAID1, RAID4, RAID5, RAID5+0, or other suitable configurations as desired. U.S. Pat. Nos. 6,694,479 and 6,643,822, both of which are incorporated herein by reference, illustrate various exemplary configurations.

In a RAID configuration, a plurality of storage devices (e.g., hard disk drives) are provided for redundancy. In a RAID configuration, data is “striped” across multiple storage devices. That is, a data set is divided up and stored across two or more storage devices. In a RAID1+0 configuration, storage devices are configured in a “mirrored” implementation in which data may be striped across two storage devices and the same data is also striped across two other storage devices. A RAID4 configuration includes a parity storage device in addition to data storage devices. Information stored on the parity storage device generally is the exclusive OR of the data on the data storage devices. In the event of a device failure, data on any of the data or parity storage devices can readily be recovered by computing the exclusive OR of the remaining storage devices. RAID5 is similar to RAID4, but parity information is rotated among the various data drives (i.e., there is no dedicated parity drive).

In the embodiment shown in FIG. 1, each button 76-84 may be assigned to a different storage device configuration thereby permitting the user to easily select any one of a plurality of storage device configurations for implementation in the storage unit 60. A label is included on, or otherwise associated with, each button 76-84 to identify the configuration associated with each button. The storage controller 64 detects when a user has pressed a button 76-84 and responds by causing the storage devices 66 to be configured as selected by the user. For example, if button 76 is associated with RAID0, then if the user presses button 76, the storage controller 64 configures the storage devices 66 for RAID0 operation.

The mechanism by which the storage controller 64 configures the storage devices 66 can implement any suitable technique, examples of which are described in some or all of the following documents, incorporated herein by reference: U.S. Pat. Nos. 6,058,489; 6,418,539; 6,269,453; and 6,061,752. For example, a software configuration utility can be included in ROM 70 or RAM 72 that can be run on the storage controller's CPU 69 to cause the CPU 69 to configure the storage devices 66 in accordance with the user-selected storage device configuration. Such a utility generally performs a function such as creating storage volumes according parameters such as size, fault tolerance (e.g., RAID), stripe size, and so on. The utility may also be used to configure various array controller parameters including cache settings and rebuild priority. As such, when a button 76-84 is pressed, an interrupt is asserted to the CPU 69 thereby causing the CPU to determine the nature of the interrupt and execute the configuration utility to configure the storage devices 66. Moreover, the storage controller 64 configures the storage devices 66 upon activation by a user of an input control (e.g., the buttons 76-84) without use of a keyboard or mouse.

The storage unit 60 of FIG. 1 permits a user to configure the storage devices 66 prior to the storage unit's initial use. A user may also change the configuration (also termed “migration”) at any appropriate time by pressing one of the buttons 76-84. When changing from one RAID configuration to another RAID configuration, the aforementioned utility may be run.

To safeguard against inadvertently pressing one of the buttons 76-84, the button interface 74 may be configured to only cause the interrupt 75 to be asserted if a button 76-84 is activated for more than a threshold amount of time (for example, 2 seconds). Further still, mechanical switch guards may be included that prevent a button from being pressed absent the guards being released and moved out of the way.

Visual feedback may be included to permit the user to know that the selected configuration has been implemented. Each button 76-84 may be implemented as a backlit button or a button having an outer rim that is illuminated. In some embodiments, the configuration may be changed while the system is operational first quiescing the storage unit 60. For example, all storage device accesses may be buffered. While the storage devices 66 are quiesced, the configuration may be changed as explained above. In other embodiments, the configuration can be changed without quiescing accesses to the storage devices 66. U.S. Pat. No. 6,058,489, incorporated herein by reference, illustrates at least one technique for changing a RAID configuration while still permitting a storage system to be operational. An example of suitable visual feedback may include illuminating the particular button 76-84 pressed by the user when the corresponding configuration has been completed. Thus, the user can determine the storage unit's configuration by visually inspecting the buttons 76-80. In some embodiments, a first visual feedback is provided when the user presses the button while the configuration is being performed and a second visual feedback is provided upon successful completion of the configuration. The first and second visual feedbacks may differ in color of an illuminated backlight. Alternatively, the backlight may blink during the configuration process and remain constant (non-blinking) after successful configuration completion. Alternatively, the button pressed may remain depressed until another button is pressed. In this way, the user can determine the configuration by determining which button is depressed.

When the user enables power to the storage unit for the first time, and if the buttons are backlit, one of the buttons 76-84 may be made to illuminate constantly or blink at a predetermined rate to indicate to the user a suggested storage device configuration. The user can elect to implement the suggested configuration by pressing the visually indicated button. Alternatively, the user can elect a different configuration by pressing another button. The configuration suggestion may be programmed during manufacturing of the storage unit and may be specific to the purchaser. For example, the storage unit manufacturer may cause the storage unit to suggest one configuration for one purchaser and a difficult configuration for another customer. The different configurations may be determined from knowledge of the purchasers' intended applications. In some embodiments, the storage unit 60 configuration may be implemented even in the absence of an affirmative choice by a user. That is, a default configuration will be implemented for the storage devices if the use does not actively make a choice. The default configuration may be implemented if user input via buttons 76-84 is detected within a predetermined amount of time following powering up of the storage unit 60 for the first time.

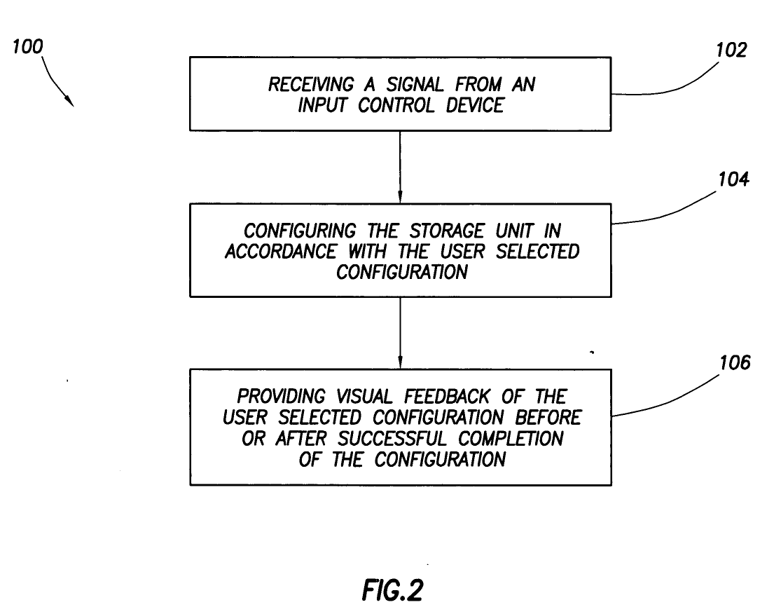

FIG. 2 shows an exemplary method 100 comprising blocks 102, 104, and 106. In block 102, the method comprise receiving a signal from an input control device. As explained above, the input control device may be connected to the storage unit 60 and may comprise a plurality of user activated input controls (e.g., buttons). The received signal is indicative of a configuration selected by a user for implementation in the storage unit. In block 104, the method comprises configuring the storage unit in accordance with the user selected configuration (e.g., RAID0, RAID1, RAID5). In block 106, the method may comprise providing visual feedback of the user selected configuration. Although the visual feedback may be provided before successful completion of the configuration, the feedback may be provided after successfully completing the configuration so the user will know that the configuration completed successfully. Although not specifically shown in FIG. 2, the method may also include, before initially configuring the storage unit, providing a visual indication of a recommended default configuration.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A storage unit, comprising:
a plurality of storage devices;
a user input device; and
a storage controller coupled to the user input device and to the storage devices and capable of configuring the storage devices in accordance with a selection made by the user via the user input device.

2. The storage unit of claim 1 wherein the user input device comprises a plurality of input controls, each control associated with one of a plurality of unique configurations and each control is adapted to cause the storage controller to configure the storage devices in accordance with the associated configuration.

3. The storage unit of claim 2 wherein the unique configurations comprise configurations from a group consisting of RAID0, RAID1+0, RAID1, RAID4, RAID5, and RAID5+0.

4. The storage unit of claim 1 wherein the storage device comprise non-volatile storage devices.

5. The storage unit of claim 1 further comprising a CPU and code executable by said CPU, said code adapted to be executed upon a user activating the user input device and said code adapted to cause said CPU to configure the storage devices.

6. The storage unit of claim 1 having a user-accessible outer surface and wherein the user input device is provided on said outer surface.

7. The storage unit of claim 6 wherein the user input device comprises a button.

8. The storage unit of claim 1 wherein the user input device provides a visual feedback of the configuration implemented by the storage controller.

9. The storage unit of claim 8 wherein the visual feedback differs while the storage devices are being configured as opposed to after the storage devices have been successfully configured.

10. The storage unit of claim 8 further comprising a visual indicator that, prior to initially configuring the storage devices, provides a visual indication of which of a plurality of configurations corresponds to a user-selectable default configuration.

11. A system comprising
a computer; and
a storage array accessible to the computer, said storage array comprising a plurality of storage devices, a controller, and a configuration control;
wherein, upon activation of said configuration control by a user and without use of a keyboard or mouse, the controller causes said plurality of storage devices to be configured in accordance with a configuration as dictated by said configuration control.

12. The system of claim 11 wherein the configuration control comprises a plurality of user-activated buttons provided on an outer surface of the storage array.

13. The system of claim 12 wherein the buttons are adapted to be back lit, and the button activated by the user to cause the storage devices to be configured is back lit to provide a visual feedback to the user as to which of a plurality of configurations has been implemented.

14. A storage unit, comprising:
means for storing data; and
means for configuring said means for storing data upon demand by a user without use of a keyboard or a mouse.

15. The storage unit of claim 14 further comprising means for providing a visual feedback of a configuration implemented by the means for configuring.

16. The storage unit of claim 14 further comprising means for providing an indication of which a plurality of configurations a user can select as a default configuration for said means for storing data.

17. A method implemented in a storage unit, comprising:
receiving a signal from an input device directly connected to the storage unit, said signal indicative of a configuration selected by a user for implementation in said storage unit; and
configuring said storage unit in accordance with the user selected configuration.

18. The method of claim 17 wherein receiving a signal from an input device comprises receiving a signal from one of a plurality of user activated input controls, each input control associated with a different configuration.

19. The method of claim 17 wherein said storage unit comprises a plurality of non-volatile strong devices and configuring said storage unit comprises configuring said storage units and said user selected configuration comprises from a group consisting of RAID0, RAID1+0, RAID1, RAID4, RAID5, and RAID5+0.

20. The method of claim 17 further comprising providing visual feedback of the user selected configuration after successfully configuring said storage unit.

21. The method of claim 17 further comprising providing a visual indication of a default configuration for the user to select.
